(19) United States
(12) Patent Application Publication
(10) Pub. No.: US 2015/0344744 A1
(43) Pub. Date: Dec. 3, 2015

(54) TIE-LAYER ADHESIVES HAVING IMPROVED ADHESION AND MELT STRENGTH

(71) Applicant: Equistar Chemicals, LP, Houston, TX (US)

(72) Inventor: Maged G. Botros, Liberty Township, OH (US)

(21) Appl. No.: 14/724,281

(22) Filed: May 28, 2015

Related U.S. Application Data
(60) Provisional application No. 62/005,493, filed on May 30, 2014.

(51) Int. Cl. C09J 123/06; B32B 7/12

(52) U.S. Cl. CPC C09J 123/06; B32B 7/12; B32B 2439/00

(57) ABSTRACT

The present disclosure provides a tie-layer adhesive comprising a first polymer composition comprising a grafted polyethylene, a second polymer composition comprising a polyethylene derived from a metallocene catalyst, a third polymer composition that comprises low density polyethylene. In general embodiments, the tie-layer adhesive comprises a primary additive and/or a secondary additive.

### TECHNICAL FIELD

In general, the present disclosure relates to the field of polymer chemistry. In particular, the present disclosure relates to polyolefins, polyethylene and grafted polyethylene. More particularly, the present disclosure relates to tie-layer adhesive compositions that may be used to bond a polyethylene based polymer layer to a barrier layer to form a multi-layer structure.

### BACKGROUND

In multilayer packaging, various layers are often combined to provide a final multilayer package. For example, structures that include different types of polyethylene, polypropylene, and ethylene vinyl acetate together with barrier layers such as ethylene vinyl alcohol (EVOH) and polyamide (PA) are often used in food packaging applications for meat and cheese. In such multilayer constructions, polypropylene typically provides stiffness, temperature resistance and scuff resistance. Polyethylene typically provides clarity and tear resistance, seals at a lower temperature and is softer than polypropylene. Styrene polymers can be included in such structures to provide structural integrity. Although it is possible to use a blend of polypropylene and polyethylene in a single layer, in conjunction with barrier and styrene polymer layers, the blend layer will not provide the full performance of a structure containing separate layers of polypropylene and polyethylene. In designing multilayered structures, adhering the separate layers is challenge that must be addressed. This is particularly the case for structures containing both polyethylene and barrier layers containing polar functional groups. It is desirable to utilize a single tie layer in a multilayer structure, otherwise in a commercial setting, capital investment would thus be required for multiple extruders, and additional extrusion steps translate to higher operating costs.

In blown film applications, the blown film usually comprises a bulk layer, a barrier layer and a tie-layer. In general, the bulk layer is the layer that has the greatest thickness in the multilayered structure. Because the bulk layer is present in the greatest thickness, the multilayered structure is primarily supported by the bulk layer. However, as the tie-layer becomes thicker, the multilayered structure depends more upon the melt strength of the tie-layer.

Tie-layers are typically present as a thin layer in a multilayered barrier structures. However, there are some examples in which a thick tie-layer is desired. In those circumstances, there still is a need for a tie-layer that has high melt strength, but does not have an adverse impact on the mechanical properties of the bulk layer. Accordingly, a continuing need exists for improved multilayer structures containing layers of polyethylene and barrier layers containing polar functional groups that are adhered to one another with a tie layer having a high melt strength.

### BRIEF SUMMARY

The present disclosure provide tie-layer adhesive compositions comprising:

(A) a first polymer composition comprising a grafted polyethylene;

(B) a second polymer composition comprising:
(i) a polyethylene derived from a metallocene based catalyst or a Zeigler-Natta (ZN) based catalyst, and
(ii) optionally, a polyethylene derived from a chromium based catalyst; and

(C) a third polymer composition that comprises a long chain branching polyethylene.

Additionally, the present disclosure provides multilayered structures comprising:

(A) a first polymer layer;

(B) a second polymer layer; and

(C) a tie-layer, wherein the tie-layer comprises:
(i) a first polymer composition comprising a grafted polyethylene;
(ii) a second polymer composition comprising:
   (a) a polyethylene derived from a metallocene based catalyst or a Zeigler-Natta (ZN) based catalyst, and
   (b) optionally, a polyethylene derived from a chromium based catalyst; and
(iii) a third polymer composition that comprises a long chain branching polyethylene,
   wherein the tie-layer is located between the first polymer layer and the second polymer layer, and is in contact with the first polymer layer and the second polymer layer.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### DETAILED DESCRIPTION

The present invention now will be described more fully hereinafter. However, this invention may be embodied in many different forms and should not be construed as limited to the embodiments set forth herein; rather, these embodiments are provided so that this disclosure will satisfy applicable legal requirements. As such, it will be apparent to those skilled in the art that the embodiments may incorporate changes and modifications without departing from the general scope of this invention. It is intended to include all such modifications and alterations in so far as they come within the scope of the appended claims or the equivalents thereof.

As used in this specification and the claims, the singular forms “a,” “an,” and “the” include plural referents unless the context clearly dictates otherwise.

As used in this specification and the claims, the terms “comprising,” “containing,” or “including” mean that at least the named compound, element, material, particle, or method step, etc., is present in the composition, the article, or the method, but does not exclude the presence of other compounds, elements, materials, particles, or method steps, etc., even if the other such compounds, elements, materials, particles, or method steps, etc., have the same function as that which is named, unless expressly excluded in the claims. It is also to be understood that the mention of one or more method steps does not preclude the presence of additional method steps before or after the combined recited steps or intervening method steps between those steps expressly identified.

Moreover, it is also to be understood that the lettering of process steps or ingredients is a convenient means for identifying discrete activities or ingredients and the recited lettering can be arranged in any sequence, unless expressly indicated.

For the purpose of the present description and of the claims which follow, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

### DEFINITIONS

As used herein, the term “LDPE” refers to low density polyethylene, which is a polyethylene with a high degree of branching with long chains. Often, the density of a LDPE will range from 0.910-0.940 g/cm³. In general, LDPE is created by free radical polymerization.

As used herein, the term “HDPE” refers to a high density polyethylene, which is a polyethylene having a density from about 0.941 to about 0.970 g/cm³.

As used herein, the term “LLDPE” refers to linear low density polyethylene, which is a polyethylene with significant numbers of short branches resulting from copolymerization of ethylene with at least one C₃₋₁₂ α-olefin comonomer, e.g., butene, hexene or octene. Typically, LLDPE has a density in the range of 0.912 to 0.927 g/cm³. In many cases, the LLDPE is an ethylene hexene copolymer, ethylene octene copolymer or ethylene butene copolymer. The amount of comonomer incorporated can be from 0.5 to 12 mol %, in some cases from 1.5 to 10 mole %, and in other cases from 2 to 8 mole % relative to ethylene. The LLDPE is produced in a single-stage or multi-stage process using a single-site catalyst, particularly a metallocene-based catalyst. Examples of LLDPE's produced in a single-state or multi-stage process using a single-site catalyst, particularly a metallocene-based catalyst are described in U.S. Pat. No. 6,194,527; U.S. Pat. No. 6,255,415.

In the present description, the terms “adhesive layer” and “tie layer” mean a layer or material placed on one or more substrates to promote the adhesion of that substrate to another layer. Preferably, adhesive layers are positioned between two layers of a multilayer film to maintain the two layers in position relative to each other and prevent undesirable delamination.

In the present description, the term “α-olefin” or “alpha-olefin” means an olefin of formula CH2═CH—R, wherein R is a linear or branched alkyl containing from 1 to 10 carbon atoms. The α-olefin can be selected, for example, from: propylene, 1-butene, 1-pentene, 1-hexene, 1-octene, 1-dodecene and the like.

In the present description, the term “grafted polyolefin” refers to a polyolefin grafted with an unsaturated monomer. The unsaturated monomer is typically an unsaturated polar monomer, preferably containing one or more oxygen atoms. Preferred examples of such unsaturated monomers will be given hereinafter.

In the present description, the term “grafted polyolefin composition” refers to a composition made from and/or containing at least one grafted polyolefin.

In the present description, the term “homopolymer” and similar terms mean a polymer consisting solely or essentially all of units derived from a single kind of monomer, e.g., ethylene homopolymer is a polymer comprising solely or essentially all of units derived from ethylene, propylene homopolymer is a polymer comprising solely or essentially all of units derived from propylene, and the like.

In the present description, the term “long-chain” refers to carbon chains that are C6 or longer. “Long chain branching (LCB)” can be determined by conventional techniques known in the industry, such as ¹³C nuclear magnetic resonance (¹³C NMR) spectroscopy, using, for example, the method of Randall (Rev. Micromole. Chem. Phys., C29 (2&3) 1989, p. 285-297). Two other methods are gel permeation chromatography, coupled with a low angle laser light scattering detector (GPC-LALLS), and gel permeation chromatography, coupled with a differential viscometer detector (GPC-DV). The use of these techniques for long chain branch detection, and the underlying theories, have been well documented in the literature. See, for example, Zimm, B. H. and Stockmayer, W. H., J. Chem. Phys., 17,1301 (1949) and Rudin, A., Modern Methods of Polymer Characterization, John Wiley & Sons, New York (1991) pp. 103-112.

In the present description, the term “long-chain branched polyolefin” refers to a polyolefin having at least 1 long chain branch per 1000 carbons.

In the present description, the term “metallocene” means a metal-containing compound having at least one substituted or unsubstituted cyclopentadienyl group bound to the metal.

In the present description, the term “metallocene-catalyzed polymer” means any polymer that is made in the presence of a metallocene catalyst.

ASTM D 1238 is entitled “Test Method for Melt Flow Rates of Thermoplastics by Extrusion Plastometer.” The term “ASTM D 1238” as used herein refers to the standard test method for determining melt flow rates of thermoplastics by extrusion plastometer. In general, this test method covers the determination of the rate of extrusion of molten thermoplastic resins using an extrusion plastometer. After a specified preheating time, resin is extruded through a die with a specified length and orifice diameter under prescribed conditions of temperature, load, and piston position in the barrel. This test method was approved on Feb. 1, 2012 and published March 2012, the contents of which are incorporated herein by reference in its entirety. For the referenced ASTM standards, visit the ASTM website, www.astm.org, or contact ASTM Customer Service at service@astm.org.

Throughout the present description and claims, all the standard melt index values are measured according to ASTM D 1238, using a piston load of 2.16 kg and at a temperature of 190 degrees Celsius. The High Load Melt Index (or HLMI) values are also measured according to ASTM D 1238, but using a piston load of 21.6 kg and at a temperature of 190 degrees Celsius.

ASTM D 1876 is entitled “Standard Test Method for Peel Resistance of Adhesives (T-Peel Test).” The term “ASTM D 1876” as used herein refers to a test method for determining the relative peel resistance of adhesive bonds between flexible adherends by means of a T-type specimen. The accuracy of the results of strength tests of adhesive bonds will depend on the conditions under which the bonding process is carried out. This test method was approved on Oct. 10, 2001 and published December 2001, the contents of which are incorporated herein by reference in its entirety. For the referenced ASTM standards, visit the ASTM website, www.astm.org, or contact ASTM Customer Service at service@astm.org.

Tie-Layer Adhesive

In general, the present disclosure provides tie-layer adhesives comprising:
(1) a first polymer composition comprising a grafted polyethylene;
(2) a second polymer composition comprising:
   (i) a polyethylene derived from a metallocene based catalyst or a Zeigler-Natta (ZN) based catalyst, and
   (ii) optionally, a polyethylene derived from a chromium based catalyst; and
(3) a third polymer composition that comprises a long chain branching polyethylene.

In some embodiments, the tie-layer adhesive comprises:
(1) a first polymer composition comprising a grafted polyethylene;
(2) a second polymer composition comprising:
   (i) a polyethylene derived from a metallocene based catalyst or a Zeigler-Natta (ZN) based catalyst, and
   (ii) optionally, a polyethylene derived from a chromium based catalyst; and;
(3) a third polymer composition that comprises a long chain branching polyethylene; and
(4) a primary additive.

In some embodiments, the tie-layer adhesive comprises:
(1) a first polymer composition comprising a grafted polyethylene;
(2) a second polymer composition comprising:
   (i) a polyethylene derived from a metallocene based catalyst or a Zeigler-Natta (ZN) based catalyst, and
   (ii) optionally, a polyethylene derived from a chromium based catalyst; and;
(3) a third polymer composition that comprises a long chain branching polyethylene; and
(4) a primary additive; and
(5) a secondary additive.

In some embodiments, the tie-layer adhesive comprises: (1) 2-25 weight (wt.) %, based on the total weight of the tie-layer adhesive, of a first polymer composition; (2) 49.8-95.8 wt. %, based on the total weight of the tie-layer adhesive, of a second polymer composition; (3) 0.01-25 wt. %, based on the total weight of the tie-layer adhesive, of a third polymer composition; (4) optionally, 0.001-2.0 wt. %, based on the total weight of the tie-layer adhesive, of a primary additive; and, (5) optionally, 0.001-2.0 wt. %, based on the total weight of the tie-layer adhesive, of a secondary additive.

In a particular embodiment, the tie-layer adhesive comprises: (1) 5.5 wt. %, based on the total weight of the tie-layer adhesive, of a first polymer composition; (2) 84.3 wt. %, based on the total weight of the tie-layer adhesive, of a second polymer composition; (3) 10 wt. %, based on the total weight of the tie-layer adhesive, of a third polymer composition; (4) 0.1 wt. %, based on the total weight of the tie-layer adhesive, of a primary additive; and, (5) 0.1 wt. %, based on the total weight of the tie-layer adhesive, of a secondary additive.

In an additional embodiment, the tie-layer adhesive comprises: (1) 5.5 wt. %, based on the total weight of the tie-layer adhesive, of a first polymer composition; (2) 94.3 wt. %, based on the total weight of the tie-layer adhesive, of a second polymer composition; (3) 0.01 wt. %, based on the total weight of the tie-layer adhesive, of a third polymer composition; (4) 0.1 wt. %, based on the total weight of the tie-layer adhesive, of a primary additive; and, (5) 0.1 wt. %, based on the total weight of the tie-layer adhesive, of a secondary additive.

In a further embodiment, the tie-layer adhesive comprises: (1) 5.5 wt. %, based on the total weight of the tie-layer adhesive, of a first polymer composition; (2) 94.3 wt. %, based on the total weight of the tie-layer adhesive, of a second polymer composition comprising a metallocene derived polyethylene and a chromium derived polyethylene; (3) 0%, based on the total weight of the tie-layer adhesive, of a third polymer composition; (4) 0.1 wt. %, based on the total weight of the tie-layer adhesive, of a primary additive; and, (5) 0.1 wt. %, based on the total weight of the tie-layer adhesive, of a secondary additive.

The First Polymer Composition

In general, the tie-layer adhesive comprises 2-25 wt. %, based on the total weight of the tie-layer adhesive, of a first polymer composition. The first polymer composition may be present in the tie-layer adhesive composition in 5-25 wt. %, based on the total weight of the tie-layer adhesive. The first polymer composition may be present in the tie-layer adhesive composition in 8-25 wt. %, based on the total weight of the tie-layer adhesive. The first polymer composition may be present in the tie-layer adhesive composition in 10-25 wt. %, based on the total weight of the tie-layer adhesive. The first polymer composition may be present in the tie-layer adhesive composition in 15-25 wt. %, based on the total weight of the tie-layer adhesive. The first polymer composition may be present in the tie-layer adhesive composition in 20-25 wt. %, based on the total weight of the tie-layer adhesive. The first polymer composition may be present in the tie-layer adhesive composition in 5-20 wt. %, based on the total weight of the tie-layer adhesive. The first polymer composition may be present in the tie-layer adhesive composition in 5-15 wt. %, based on the total weight of the tie-layer adhesive. The first polymer composition may be present in the tie-layer adhesive composition in 5-13 wt. %, based on the total weight of the tie-layer adhesive. The first polymer composition may be present in the tie-layer adhesive composition in 4-8 wt. %, based on the total weight of the tie-layer adhesive. The first polymer composition may be present in the tie-layer adhesive composition in 5.5 wt. %, based on the total weight of the tie-layer adhesive.

In general embodiments, the first polymer composition is a grafted homopolymer or copolymer of polyethylene. The grafted polyethylene contains acid or acid derivative functionality, and is obtained by reacting ethylenically unsaturated carboxylic acids and carboxylic acid anhydrides, or derivatives thereof, with polyethylene under grafting conditions. The grafting monomers, i.e., acid, anhydride or derivative, are incorporated along the polyethylene. In some examples, the polyethylene to be grafted includes ethylene homopolymers and copolymers of ethylene with propylene, butene, 4-methyl pentene, hexene, octene, or mixtures thereof. More preferably, the grafted polyethylene is an HDPE or an LLDPE. Most preferably, the grafted polyethylene is an HDPE.

Carboxylic acids or anhydrides useful as grafting monomers include compounds such as acrylic acid, maleic acid, fumaric acid, citaconic acid, mesaconic acid, maleic anhydride, 4-methyl cyclohex-4-ene-1,2-dicarboxylic acid or anhydride, bicyclo(2.2.2)oct-5-ene-2,3-dicarboxylic acid or anhydride 2-oxa-1,3-diketospiro(4,4)non-7-ene, bicyclo(2.2.1)hept-5-ene-2,3-dicarboxylic acid or anhydride, tetrahydrophthalic acid or anhydride, x-methylbicyclo(2.2.1)hept-5-ene-2,3-dicarboxylic acid or anhydride, nadic anhydride, methyl nadic anhydride, himic anhydride, and methyl himic anhydride. Maleic anhydride is a particularly useful grafting monomer. Acid and anhydride derivatives which can be used to graft the polyethylene include dialkyl maleates, dialkyl fumarates, dialkyl itaconates, dialkyl mesaconates, dialkyl citraconates and alkyl crotonates.

Grafting is accomplished by thermal and/or mechanical means in accordance with known procedures, with or without a free-radical generating catalyst such as an organic peroxide, where the grafted sample is prepared by heating a mixture of the polyolefin and graft monomer(s), with or without a solvent, while subjecting it to high shear. Preferably, the grafted products are prepared by melt blending the polyethylene in the substantial absence of a solvent, in the presence of the grafting monomer in a shear-imparting reactor, such as an extruder. Twin screw extruders such as those marketed by Werner-Pfleiderer under the designations ZSK-30, ZSK-53, ZSK-83, ZSK-90 and ZSK-92 are especially useful for carrying out the grafting operation. Preferably, the amount of acid or acid derivative comonomer(s) grafted onto the polyethylene ranges from 0.1 to 4 weight percent, preferably from 0.5 to 3.0 weight percent. Preferably, when maleic anhydride is grafted onto HDPE or LLDPE, the grafted maleic anhydride concentration is 0.5 to 4 weight percent. Melt indexes of the grafted ethylene polymers (MI) are preferably 1 to 20 dg/min as measured by ASTM D 1238, at 190° C., 2.16 kg.

The grafting reaction is carried out at a temperature selected to minimize or avoid rapid vaporization and consequent losses of the graft monomer and any catalyst that may be employed. The graft monomer concentration in the reactor is typically about 1 to about 5 wt. % based on the total reaction mixture weight. In general the grafting reaction is carried out according to a temperature profile in which the temperature of the polyolefin melt increases gradually through the length of the extruder/reactor up to a maximum temperature in the grafting reaction zone and then decreases toward the reactor exit is preferred. The maximum temperature within the reactor should be such that significant vaporization losses and/or premature decomposition of any peroxide catalyst are avoided. The grafting monomer and any catalyst used are preferably added in neat form to the extruder/reactor.

The Second Polymer Composition

In general, the tie-layer adhesive comprises 49.8-95.8 wt. %, based on the total weight of the tie-layer adhesive, of a second polymer composition. The second polymer composition may be present in the tie-layer adhesive composition in 54.8-95.8 wt. %, based on the total weight of the tie-layer adhesive. The second polymer composition may be present in the tie-layer adhesive composition in 59.8-95.8 wt. %, based on the total weight of the tie-layer adhesive. The second polymer composition may be present in the tie-layer adhesive composition in 64.8-95.8 wt. %, based on the total weight of the tie-layer adhesive. The second polymer composition may be present in the tie-layer adhesive composition in 69.8-95.8 wt. %, based on the total weight of the tie-layer adhesive. The second polymer composition may be present in the tie-layer adhesive composition in 74.8-95.8 wt. %, based on the total weight of the tie-layer adhesive. The second polymer composition may be present in the tie-layer adhesive composition in 79.8-95.8 wt. %, based on the total weight of the tie-layer adhesive. The second polymer composition may be present in the tie-layer adhesive composition in 84.8-95.8 wt. %, based on the total weight of the tie-layer adhesive. The second polymer composition may be present in the tie-layer adhesive composition in 89.8-95.8 wt. %, based on the total weight of the tie-layer adhesive. The second polymer composition may be present in the tie-layer adhesive composition in 94.8-95.8 wt. %, based on the total weight of the tie-layer adhesive. The second polymer composition may be present in the tie-layer adhesive composition in 84.3-94.3 wt. %, based on the total weight of the tie-layer adhesive. The second polymer composition may be present in the tie-layer adhesive composition in 84.3 wt. %, based on the total weight of the tie-layer adhesive. The second polymer composition may be present in the tie-layer adhesive composition in 94.3 wt. %, based on the total weight of the tie-layer adhesive.

In general embodiments, the second polymer composition comprises a metallocene derived homopolymer or copolymer of polyethylene. In some embodiments, the second polymer composition comprises a Zeigler-Natta derived homopolyer or copolymer of polyethylene. In some embodiments, the second polymer composition comprises a chromium derived homopolyer or copolymer of polyethylene. In particular embodiments, the second polymer composition comprises a linear low density polyethylene (LLDPE).

In general embodiments, the second polymer composition may comprise a metallocene derived homopolymer or copolymer of polyethylene and/or a chromium derived polyethylene. In specific embodiments, the second polymer composition comprises a metellocene derived homopolyer or copolymer of polyethylene. In some embodiments, the second polymer composition comprises a chromium derived polyethylene. In additional embodiments, the second polymer composition comprises both a metallocene derived homopolymer or copolymer of polyethylene, and a chromium derived homopolymer or copolymer of polyethylene. In general embodiments, the second polymer composition comprises ethylene derived monomeric units and hexene derived monomeric units.

In general embodiments, the second polymer composition comprises:
(i) 0 to 100 wt. %, based upon the total weight of the second polymer composition, of a metallocene or a Zeigler-Natta derived polyethylene; and
(ii) 0 to 100 wt. %, based upon the total weight of the second polymer composition of a chromium derived polyethylene.

In general, the second polymer composition comprises 10 to 100 wt. %, based upon the total weight of the second polymer composition of a metallocene or a Zeigler-Natta derived polyethylene. In some embodiments, the second polymer composition comprises 50 to 100 wt. %, based upon the total weight of the second polymer composition, of a metallocene or a Zeigler-Natta derived polyethylene. In some embodiments, the second polymer composition comprises 60 to 100 wt. %, based upon the total weight of the second polymer composition, of a metallocene or a Zeigler-Natta derived polyethylene. In some embodiments, the second polymer composition comprises 70 to 100 wt. %, based upon the total weight of the second polymer composition, of a metallocene or a Zeigler-Natta derived polyethylene. In some embodiments, the second polymer composition comprises 80 to 100 wt. %, based upon the total weight of the second polymer composition, of a metallocene or a Zeigler-Natta derived polyethylene. In some embodiments, the second polymer composition comprises 88 to 100 wt. %, based upon the total weight of the second polymer composition, of a metallocene or a Zeigler-Natta derived polyethylene. In some embodiments, the second polymer composition comprises about 89 wt. %, based upon the total weight of the second polymer composition, of a metallocene or a Zeigler-Natta derived polyethylene. In some embodiments, the second polymer composition comprises about 89 wt. %, based upon the total weight of the second polymer composition, of a metallocene or a Zeigler-Natta derived polyethylene.

In general, the second polymer composition comprises 10 to 99 wt. %, based upon the total weight of the second polymer composition of a metallocene or a Zeigler-Natta derived polyethylene, and 1 to 90 wt. %, based upon the total weight of the second polymer composition, of a chromium derived polyethylene. In some embodiments, the second polymer composition comprises 50 to 99 wt. %, based upon the total weight of the second polymer composition, of a metallocene or a Zeigler-Natta derived polyethylene, and 1 to 50 wt. %, based upon the total weight of the second polymer composition, of a chromium derived polyethylene. In some embodiments, the second polymer composition comprises 60 to 99 wt. %, based upon the total weight of the second polymer composition, of a metallocene or a Zeigler-Natta derived polyethylene, and 1 to 40 wt. %, based upon the total weight of the second polymer composition, of a chromium derived polyethylene. In some embodiments, the second polymer composition comprises 70 to 99 wt. %, based upon the total weight of the second polymer composition, of a metallocene or a Zeigler-Natta derived polyethylene, and 1 to 30 wt. %, based upon the total weight of the second polymer composition, of a chromium derived polyethylene. In some embodiments, the second polymer composition comprises 80 to 99 wt. %, based upon the total weight of the second polymer composition, of a metallocene or a Zeigler-Natta derived polyethylene, and 1 to 20 wt. %, based upon the total weight of the second polymer composition, of a chromium derived polyethylene. In some embodiments, the second polymer composition comprises 88 to 99 wt. %, based upon the total weight of the second polymer composition, of a metallocene or a Zeigler-Natta derived polyethylene, and 1 to 22 wt. %, based upon the total weight of the second polymer composition, of a chromium derived polyethylene. In some embodiments, the second polymer composition comprises about 89 wt. %, based upon the total weight of the second polymer composition, of a metallocene or a Zeigler-Natta derived polyethylene, and about 11 wt. %, based upon the total weight of the second polymer composition, of a chromium derived polyethylene. In some embodiments, the second polymer composition comprises about 0 wt. %, based upon the total weight of the second polymer composition, of a metallocene or a Zeigler-Natta derived polyethylene, and 100 wt. %, based upon the total weight of the second polymer composition, of a chromium derived polyethylene.

In general embodiments, the second polymer composition has a melt index (190/2.16 test method ASTM D 1238) from 0.5 and 1.5 g/10 min. In some embodiments, the second polymer composition has a melt index between 0.75 and 1.0 g/10 min. In particular embodiments, the second polymer composition has a melt index of 0.75 g/10 min. In specific embodiments, the second polymer composition has a melt index of 1.0 g/10 min.

In general embodiments, the second polymer composition has a density between 0.910 and 0.92 g/cm³. In some embodiments, the second polymer composition has a density between 0.912 and 0.918 g/cm³. In specific embodiments, the second polymer composition has a density between 0.912 and 0.913 g/cm³. In particular embodiments, the second polymer composition has a density of 0.918 g/cm³.

In general embodiments, the second polymer composition has a polydispersity index, Mw/Mn, between 2 and 10. In some embodiments, the second polymer composition has a polydispersity index between 2.5 and 5.75. In specific embodiments, the second polymer composition has a polydispersity index of about 2.75. In specific embodiments, the second polymer composition has a polydispersity index of about 3.0. In specific embodiments, the second polymer composition has a polydispersity index of about 3.25. In specific embodiments, the second polymer composition has a polydispersity index of about 3.75. In specific embodiments, the second polymer composition has a polydispersity index of about 4.0. In specific embodiments, the second polymer composition has a polydispersity index of about 4.25. In specific embodiments, the second polymer composition has a polydispersity index of about 4.5. In specific embodiments, the second polymer composition has a polydispersity index of about 4.75. In specific embodiments, the second polymer composition has a polydispersity index of about 5.0. In specific embodiments, the second polymer composition has a polydispersity index of about 5.25. In particular embodiments, the second polymer composition has a polydispersity index of about 5.5. In specific embodiments, the second polymer composition has a polydispersity index of about 5.75.

In general embodiments, the second polymer composition has a mass-average molecular mass (Mw) between about 75,000 and about 150,000 Daltons (Da) or between about 75,000 and about 150,000 g/mol. In some embodiments, the second polymer composition has an Mw between about 80,000 and about 140,000 Daltons (Da) or between about 80,000 and about 140,000 g/mol. In some embodiments, the second polymer composition has an Mw between about 110,000 and about 135,000 Daltons (Da) or between about 110,000 and about 135,000 g/mol. In some embodiments, the second polymer composition has an Mw between about 115,000 and about 135,000 Daltons (Da) or between about 115,000 and about 135,000 g/mol. In specific embodiments, the second polymer composition has an Mw of about 115,000 g/mol. In specific embodiments, the second polymer composition has an Mw of about 120,000 g/mol. In particular embodiments, the second polymer composition has an Mw of about 125,000 g/mol. In additional embodiments, the second polymer composition has an Mw of about 130,000 g/mol.

In general, the second polymer composition has a number average molar mass (Mn) between about 18,000 and about 50,000 Da or between about 18,000 and about 50,000 g/mol. In some embodiments, the second polymer composition has an Mn between about 20,000 g/mol and about 45,000 g/mol. In particular embodiments, the second polymer composition has an Mn of about 20,000 g/mol. In some embodiments, the second polymer composition has an Mn of about 25,000 g/mol. In specific embodiments, the second polymer composition has an Mn of about 30,000 g/mol. In particular embodiments, the second polymer composition has an Mn of about 35,000 g/mol. In some embodiments, the second polymer composition has an Mn of about 40,000 g/mol. In additional embodiments, the second polymer composition has an Mn of about 45,000 g/mol.

In general, the second polymer composition has a melting point as measured by DSC between about 115 and about 118° C. In some embodiments, the second polymer composition has a content of hexene derived units of about 5 to 15 wt. % based upon the total weight of the second polymer composition. In some embodiments, the second polymer composition has a content of hexene derived units of about 6 wt. %, based upon the total weight of the second polymer composition. In some embodiments, the second polymer composition has a content of hexene derived units of about 7 wt. %, based upon the total weight of the second polymer composition. In some embodiments, the second polymer composition has a content of hexene derived units of about 8 wt. %, based upon the total weight of the second polymer composition. In some embodiments, the second polymer composition has a content of hexene derived units of about 9 wt. %, based upon the total weight of the second polymer composition. In some embodiments, the second polymer composition has a content of hexene derived units of about 10 wt. %, based upon the total weight of the second polymer composition. In some embodiments, the second polymer composition has a content of hexene derived units of about 11 wt. %, based upon the total weight of the second polymer composition. In some embodiments, the second polymer composition has a content of hexene derived units of about 12 wt. %, based upon the total weight of the second polymer composition. In some embodiments, the second polymer composition has a content of hexene derived units of about 13 wt. %, based upon the total weight of the second polymer composition. In some embodiments, the second polymer composition has a content of hexene derived units of about 14 wt. %, based upon the total weight of the second polymer composition. In some embodiments, the second polymer composition has a content of hexene derived units of about 15 wt. %, based upon the total weight of the second polymer composition.

Third Polymer Composition

In particular embodiments, the tie-layer adhesive comprises 0.01-25 wt. %, based on the total weight of the tie-layer adhesive, of a third polymer composition. The third polymer composition may be present in the tie-layer adhesive composition in an amount ranges from 2-20 wt. %, based on the total weight of the tie-layer adhesive. The third polymer composition may be present in the tie-layer adhesive composition in an amount ranging from 2-18 wt. %, based on the total weight of the tie-layer adhesive. The third polymer composition may be present in the tie-layer adhesive composition in an amount ranging from 2-15 wt. %, based on the total weight of the tie-layer adhesive. The third polymer composition may be present in the tie-layer adhesive composition in an amount ranging from 5-20 wt. %, based on the total weight of the tie-layer adhesive. The third polymer composition may be present in the tie-layer adhesive composition in an amount ranging from 7-20 wt. %, based on the total weight of the tie-layer adhesive. The third polymer composition may be present in the tie-layer adhesive composition in an amount ranging from 10-20 wt. %, based on the total weight of the tie-layer adhesive. The third polymer composition may be present in the tie-layer adhesive composition in an amount ranging from 15-20 wt. %, based on the total weight of the tie-layer adhesive. The third polymer composition may be present in the tie-layer adhesive composition in an amount ranging from 7-12 wt. %, based on the total weight of the tie-layer adhesive. The third polymer composition may be present in the tie-layer adhesive composition in an amount ranging from 8-11 wt. %, based on the total weight of the tie-layer adhesive. The third polymer composition may be present in the tie-layer adhesive composition in about 10 wt. %, based on the total weight of the tie-layer adhesive.

In general, the third polymer composition is a homopolymer or copolymer of polyethylene. In particular, the third polymer composition is a low density polyethylene (LDPE). Suitable long-chain branched polyolefins include polyethylenes having long-chain branching. Preferably, the long-chain branched polyolefin is a low density polyethylene (LDPE). The LDPE can be an ethylene homopolymer or ethylene copolymerized with one or more monomers, such as vinyl acetate, methyl acrylate, acrylic acid, ethyl acrylate, or a C₃ to C₁₀ α-olefin.

The third polymer composition can have a density from about 0.900 g/cm³ to about 0.930 g/cm³. In some embodiments, the third polymer composition may have a density in a range from 0.910 g/cm³ to about 0.9250 g/cm³. In some embodiments, the third polymer composition may have a density in a range from 0.915 g/cm³ to about 0.9200 g/cm³. The third polymer composition can have a melt index, measured according to ASTM D 1238 at a load of 2.16 kg and a temperature of 190 degrees Celsius, ranging from about 0.10 g/10 min to about 25.0 g/10 min. In some embodiments, the third polymer composition may have a melt index, measured according to ASTM D 1238 at a load of 2.16 kg and a temperature of 190 degrees Celsius, ranging from about 0.1 g/10 min to about 10.0 g/10 min.

The third polymer composition is preferably a LDPE prepared by free radical, high pressure polymerization, in particular by using a tubular or autoclave high pressure polymerization process in the presence of a free radical initiator.

In a specific embodiment, the third polymer composition is a LDPE. In particular embodiments, the third polymer composition is an ethylene homopolymer with a density of about 0.918 g/cm³ and a melt index of about 0.25 g/10 min. Suitable LDPE polymers include the Petrothene™ series LDPE resins such as Petrothene™ NA940, which are products of Equistar Chemicals, LP.

Additives

In general, a variety of primary and secondary additives may be incorporated into the embodiments described above used to make the blends and films for various purposes. Such additives include, for example, stabilizers, antioxidants, fillers, colorants, and antiblock agents. Primary and secondary include antioxidants. Specific antioxidants include, for example, hindered phenols, hindered amines, and phosphites. Nucleating agents include, for example, sodium benzoate and talc. Also, other nucleating agents may also be employed such as Ziegler-Natta olefin product or other highly crystalline polymer. Antiblock agents include amorphous silicas, talc, zin stearate among others. Additives such as dispersing agents, for example, Acrowax C, can also be included. Catalyst deactivators are also commonly used, for example, calcium stearate, hydrotalcite, and calcium oxide, and/or other acid neutralizers known in the art.

Other additives include, for example, fire/flame retardants, plasticizers, vulcanizing or curative agents, vulcanizing or curative accelerators, cure retarders, processing aids, tackifying resins, and the like. The aforementioned additives may also include fillers and/or reinforcing materials, either added independently or incorporated into an additive. Examples include carbon black, clay, talc, calcium carbonate, mica, silica, silicate, combinations thereof, and the like. Other additives which may be employed to enhance properties include lubricants and UV stabilizers. The lists described herein are not intended to be inclusive of all types of additives which may be employed with the present invention. Upon reading this disclosure, those of skilled in the art will appreciate other additives may be employed to enhance properties. As is understood by the skilled in the art, the blends of the present invention may be modified to adjust the characteristics of the blends as desired.

In general, the tie-layer adhesive comprises 0.001-2.0%, based on the total weight of the tie-layer adhesive, of a primary additive. The primary additive may be present in the tie-layer adhesive composition in 0.01-2.0%, based on the total weight of the tie-layer adhesive. The primary additive may be present in the tie-layer adhesive composition in 0.01-1.5%, based on the total weight of the tie-layer adhesive. The primary additive may be present in the tie-layer adhesive composition in 0.01-1.0%, based on the total weight of the tie-layer adhesive. The primary additive may be present in the tie-layer adhesive composition in 0.01-0.75%, based on the total weight of the tie-layer adhesive. The primary additive may be present in the tie-layer adhesive composition in 0.01-0.5%, based on the total weight of the tie-layer adhesive. The primary additive may be present in the tie-layer adhesive composition in 0.05-0.25%, based on the total weight of the tie-layer adhesive. The primary additive may be present in the tie-layer adhesive composition in 0.07-0.15%, based on the total weight of the tie-layer adhesive. The primary additive may be present in the tie-layer adhesive composition in 0.1%, based on the total weight of the tie-layer adhesive.

Examples of the primary additive include but are not limited to phosphorus based antioxidants, phenol-based antioxidants, sulfur-based antioxidants and combinations thereof. Specific examples of the phosphorus-based antioxidant include tris(nonylphenyl)phosphite; tris(2,4-di-t-butylphenyl)phosphite; distearylpentaerythritol diphosphite; bis(2,4-di-t-butylphenyl)pentaerythritol phosphite; bis(2,6-di-t-butyl-4-methylphenyl)pentaerythritol phosphite; 2,2-methylenebis(4,6-di-t-butylphenyl)octyl phosphite; tetrakis(2,4-di-t-butylphenyl)-4,4-biphenylene-di-phosphonite; Adekastab 1178 (Asahi Denka Co., Ltd.); Sumilizer TNP (Sumitomo Chemical Co., Ltd.); JP-135 (Johoku Kagaku K. K.); Adekastab 2112 (Asahi Denka Co., Ltd.); JPP-2000 (Johoku Kagaku K. K.); Weston618 (General Electric Co.); Adekastab PEP-24G (Asahi Denka Co., Ltd.); Adekastab PEP-36 (Asahi Denka Co., Ltd.); Adekastab HP-10 (Asahi Denka Co., Ltd.); SandstabP-EPQ (Sandoz Ltd.); and Phosphite 168 (Ciba Specialty Chemicals Corp.).

Specific examples of the phenol-based antioxidant include 2,6-di-t-butyl-4-methylphenol; n-octadecyl-3-(3′,5′-di-t-butyl-4′-hydroxyphenyl)propionate; tetrakis[methylene-3-(3,5-di-t-butyl-4-hydroxyphenyl)propionate]methane; tris(3,5-di-t-butyl-4-hydroxybenzyl)isocyanurate; 4,4′-butylidenebis-(3-methyl-6-t-butylphenol); triethylene glycol-bis[3-(3-t-butyl-4-hydroxy-5-methylphenyl)propionate]; 3,9-bis{2-[3-(3-t-butyl-4-hydroxy-5-methylphenyl)propionyloxy]-1,1-dimethy lethyl}-2,4,8,10-tetraoxaspiro[5,5]undecane; Sumilizer BHT (Sumitomo Chemical Co., Ltd.); Yoshinox BHT (Yoshitomi Pharmaceutical Industries, Ltd.); Antage BHT (Kawaguchi Chemical Industry Co., Ltd.); Irganox 1076 (Ciba Specialty Chemicals Corp.); Irganox 1010 (Ciba Specialty Chemicals Corp.); Adekastab AO-60 (Asahi Denka Co., Ltd.); Sumilizer BP-101 (Sumitomo Chemical Co., Ltd.); Tominox TT (Yoshitomi Pharmaceutical Industries, Ltd.); TTHP (Toray Industries, Inc.); Irganox 3114 (Ciba Specialty Chemicals Corp.); Adekastab AO-20 (Asahi Denka Co., Ltd.); Adekastab AO-40 (Asahi Denka Co., Ltd.); Sumilizer BBM-S(Sumitomo Chemical Co., Ltd.); Yoshinox BB (Yoshitomi Pharmaceutical Industries, Ltd.); Antage W-300 (Kawaguchi Chemical Industry Co., Ltd.); Irganox 245 (Ciba Specialty Chemicals Corp.); Adekastab AO-70 (Asahi Denka Co., Ltd.); Tominox 917 (Yoshitomi Pharmaceutical Industries, Ltd.); Adekastab AO-80 (Asahi Denka Co., Ltd.); and Sumilizer GA-80 (Sumitomo Chemical Co., Ltd.).

Specific examples of the sulfur-based antioxidant include dilauryl 3,3′-thiodipropionate; dimyristyl 3,3′-thiodipropionate; distearyl 3,3′-thiodipropionate; pentaerythritol tetrakis(3-lauryl thiopropionate); Sumilizer TPL (Sumitomo Chemical Co., Ltd.); Yoshinox DLTP (Yoshitomi Pharmaceutical Industries, Ltd.); Antiox L (Nippon Oil & Fats Co., Ltd.); Sumilizer TPM (Sumitomo Chemical Co., Ltd.); Yoshinox DMTP (Yoshitomi Pharmaceutical Industries, Ltd.); Antiox M (Nippon Oil & Fats Co., Ltd.); Sumilizer TPS (Sumitomo Chemical Co., Ltd.); Yoshinox DSTP (Yoshitomi Pharmaceutical Industries, Ltd.); Antiox S (Nippon Oil & Fats Co., Ltd.); Adekastab AO-412S (Asahi Denka Co., Ltd.); SEENOX 412S (Shipro Kasei Kaisha, Ltd.); and Sumilizer TDP (Sumitomo Chemical Co., Ltd.).

Of these, Irganox 1010 (substance name: pentaerythritolyl tetrakis[3-(3,5-di-t-butyl-4-hydroxyphenyl)propionate]); Irgaphos 168 (substance name: tris(2,4-di-t-butylphenyl)phosphite); Irganox 1076 (substance name: octadecyl 3-(3,5-di-t-butyl-4-hydroxyphenyl)propionate); Irganox 1330 (substance name: 1,3,5-trimethyl-2,4,6-tris(3,5-di-t-butyl-4-hydroxybenzyl)benzene); Irganox 3114 (substance name: tris(3,5-di-t-butyl-4-hydroxybenzyl) isocyanurate); and P-EPQ (substance name: tetrakis(2,4-di-t-butylphenyl) 4,4′-biphenylene-di-phosphite) are particularly preferred.

In general, the tie-layer adhesive comprises 0.001-2.0%, based on the total weight of the tie-layer adhesive, of a secondary additive. The secondary additive may be present in the tie-layer adhesive composition in 0.01-2.0%, based on the total weight of the tie-layer adhesive. The secondary additive may be present in the tie-layer adhesive composition in 0.01-1.5%, based on the total weight of the tie-layer adhesive. The secondary additive may be present in the tie-layer adhesive composition in 0.01-1.0%, based on the total weight of the tie-layer adhesive. The secondary additive may be present in the tie-layer adhesive composition in 0.01-0.75%, based on the total weight of the tie-layer adhesive. The secondary additive may be present in the tie-layer adhesive composition in 0.01-0.5%, based on the total weight of the tie-layer adhesive. The secondary additive may be present in the tie-layer adhesive composition in 0.05-0.25%, based on the total weight of the tie-layer adhesive. The secondary additive may be present in the tie-layer adhesive composition in 0.07-0.15%, based on the total weight of the tie-layer adhesive. The secondary additive may be present in the tie-layer adhesive composition in 0.1%, based on the total weight of the tie-layer adhesive.

Examples of the secondary additive include but are not limited to phosphorus based antioxidants, phenol-based antioxidants, sulfur-based antioxidants and combinations thereof. Specific examples of the phosphorus-based antioxidant include tris(nonylphenyl)phosphite; tris(2,4-di-t-butylphenyl)phosphite; distearylpentaerythritol diphosphite; bis(2,4-di-t-butylphenyl)pentaerythritol phosphite; bis(2,6-di-t-butyl-4-methylphenyl)pentaerythritol phosphite; 2,2-methylenebis(4,6-di-t-butylphenyl)octyl phosphite; tetrakis(2,4-di-t-butylphenyl)-4,4-biphenylene-di-phosphonite; Adekastab 1178 (Asahi Denka Co., Ltd.); Sumilizer TNP (Sumitomo Chemical Co., Ltd.); JP-135 (Johoku Kagaku K. K.); Adekastab 2112 (Asahi Denka Co., Ltd.); JPP-2000 (Johoku Kagaku K. K.); Weston618 (General Electric Co.); Adekastab PEP-24G (Asahi Denka Co., Ltd.); Adekastab PEP-36 (Asahi Denka Co., Ltd.); Adekastab HP-10 (Asahi Denka Co., Ltd.); SandstabP-EPQ (Sandoz Ltd.); and Phosphite 168 (Ciba Specialty Chemicals Corp.).

Specific examples of the phenol-based antioxidant include 2,6-di-t-butyl-4-methylphenol; n-octadecyl-3-(3′,5′-di-t-butyl-4′-hydroxyphenyl) propionate; tetrakis[methylene-3-(3,5-di-t-butyl-4-hydroxyphenyl)propionate]methane; tris(3,5-di-t-butyl-4-hydroxybenzyl)isocyanurate; 4,4′-butylidenebis-(3-methyl-6-t-butylphenol); triethylene glycol-bis[3-(3-t-butyl-4-hydroxy-5-methylphenyl) propionate]; 3,9-bis{2-[3-(3-t-butyl-4-hydroxy-5-methylphenyl)propionyloxy]-1,1-dimethy lethyl}-2,4,8,10-tetraoxaspiro[5,5]undecane; Sumilizer BHT (Sumitomo Chemical Co., Ltd.); Yoshinox BHT (Yoshitomi Pharmaceutical Industries, Ltd.); Antage BHT (Kawaguchi Chemical Industry Co., Ltd.); Irganox 1076 (Ciba Specialty Chemicals Corp.); Irganox 1010 (Ciba Specialty Chemicals Corp.); Adekastab AO-60 (Asahi Denka Co., Ltd.); Sumilizer BP-101 (Sumitomo Chemical Co., Ltd.); Tominox TT (Yoshitomi Pharmaceutical Industries, Ltd.); TTHP (Toray Industries, Inc.); Irganox 3114 (Ciba Specialty Chemicals Corp.); Adekastab AO-20 (Asahi Denka Co., Ltd.); Adekastab AO-40 (Asahi Denka Co., Ltd.); Sumilizer BBM-S(Sumitomo Chemical Co., Ltd.); Yoshinox BB (Yoshitomi Pharmaceutical Industries, Ltd.); Antage W-300 (Kawaguchi Chemical Industry Co., Ltd.); Irganox 245 (Ciba Specialty Chemicals Corp.); Adekastab AO-70 (Asahi Denka Co., Ltd.); Tominox 917 (Yoshitomi Pharmaceutical Industries, Ltd.); Adekastab AO-80 (Asahi Denka Co., Ltd.); and Sumilizer GA-80 (Sumitomo Chemical Co., Ltd.).

Specific examples of the sulfur-based antioxidant include dilauryl 3,3′-thiodipropionate; dimyristyl 3,3′-thiodipropionate; distearyl 3,3′-thiodipropionate; pentaerythritol tetrakis(3-lauryl thiopropionate); Sumilizer TPL (Sumitomo Chemical Co., Ltd.); Yoshinox DLTP (Yoshitomi Pharmaceutical Industries, Ltd.); Antiox L (Nippon Oil & Fats Co., Ltd.); Sumilizer TPM (Sumitomo Chemical Co., Ltd.); Yoshinox DMTP (Yoshitomi Pharmaceutical Industries, Ltd.); Antiox M (Nippon Oil & Fats Co., Ltd.); Sumilizer TPS (Sumitomo Chemical Co., Ltd.); Yoshinox DSTP (Yoshitomi Pharmaceutical Industries, Ltd.); Antiox S (Nippon Oil & Fats Co., Ltd.); Adekastab AO-412S (Asahi Denka Co., Ltd.); SEENOX 412S (Shipro Kasei Kaisha, Ltd.); and Sumilizer TDP (Sumitomo Chemical Co., Ltd.).

Of these, Irganox 1010 (substance name: pentaerythritolyl tetrakis[3-(3,5-di-t-butyl-4-hydroxyphenyl)propionate]); Irgaphos 168 (substance name: tris(2,4-di-t-butylphenyl)phosphite); Irganox 1076 (substance name: octadecyl 3-(3,5-di-t-butyl-4-hydroxyphenyl)propionate); Irganox 1330 (substance name: 1,3,5-trimethyl-2,4,6-tris(3,5-di-t-butyl-4-hydroxybenzyl)benzene); Irganox 3114 (substance name: tris(3,5-di-t-butyl-4-hydroxybenzyl) isocyanurate); and P-EPQ (substance name: tetrakis(2,4-di-t-butylphenyl) 4,4′-biphenylene-di-phosphite) are particularly preferred.

In some embodiments, the tie-layer adhesive compositions disclosed herein are included in a multilayer film. In some examples, the multilayer film is coextruded with layers that contain a LDPE, a HDPE, a LLDPE, and/or a polyamide.

Multilayer Structure

In some embodiments, the present disclosure provides multilayered structures comprising:

(A) a first polymer layer;

(B) a second polymer layer; and

(C) a tie-layer

with the tie-layer being located between the first polymer layer and the second polymer layer, and is in contact with the first polymer layer and the second polymer layer.

In some embodiments, the present disclosure provides multilayered structures comprising:

(A) a first polymer layer;

(B) a second polymer layer;

(C) a first tie-layer;

(D) a third polymer layer; and

(E) a second tie-layer,

with the first tie-layer being located between the first polymer layer and the second polymer layer, and is in contact with the first polymer layer and the second polymer layer. The second tie-layer is located between the second polymer layer and the third polymer layer, and is in contact with the second polymer layer and the third polymer layer.

In multilayer packaging, various layers are often combined to provide a final product that has the characteristics of the separate layers. The multilayered structures as disclosed herein may contain at least one tie-layer made of the tie-layer adhesive compositions as disclosed herein. Structures that include different types of layers that include layers made of polyethylene (PE), polypropylene (PP), and/or ethylene vinyl acetate (EVA) together with barrier layers such as ethylene vinyl alcohol (EVOH) and polyamide (PA) are often used in number of applications, including packaging.

In some examples, the multilayer structure is a three-layered multilayered structure and contains:
(i) 40 to 50 wt. %, based upon the total weight of the multilayer structure, of a first polymer layer;
(ii) 1 to 8 wt. %, based upon the total weight of the multilayer structure, of a first adhesive layer; and
(iii) 40 to 50 wt. %, based upon the total weight of the multilayer structure, of a second polymer layer.

In some examples, the multilayer structure is a five-layered multilayered structure and contains:
(i) 40 to 50 wt. %, based upon the total weight of the multilayer structure, of a first polymer layer;
(ii) 1 to 8 wt. %, based upon the total weight of the multilayer structure, of a first adhesive layer;
(iii) 1 to 10 wt. %, based upon the total weight of the multilayer structure, of a second polymer layer;
(iv) 1 to 8 wt. %, based upon the total weight of the multilayer structure, of a second adhesive layer; and
(v) 40 to 50 wt. %, based upon the total weight of the multilayer structure, of a third polymer layer.

In some examples, the multilayer structure is a seven-layered multilayered structure and contains:
(i) 40 to 50 wt. %, based upon the total weight of the multilayer structure, of a first polymer layer;
(ii) 1 to 8 wt. %, based upon the total weight of the multilayer structure, of a first adhesive layer;
(iii) 1 to 10 wt. %, based upon the total weight of the multilayer structure, of a second polymer layer;
(iv) 1 to 8 wt. %, based upon the total weight of the multilayer structure, of a second adhesive layer;
(v) 1 to 10 wt. %, based upon the total weight of the multilayer structure, of a third polymer layer;
(vi) 1 to 10 wt. %, based upon the total weight of the multilayer structure, of a third tie-layer; and
(vii) 40 to 50 wt. %, based upon the total weight of the multilayer structure, of a fourth polymer layer.

Barrier Layers

In some embodiments, the multilayer structure may include a polymer layer that is a barrier layer. In some embodiments, the multilayer structure includes at least one barrier layer. In particular embodiments, the second and/or third polymer layer is a barrier layer. A barrier layer may include ethylene vinyl alcohol copolymer (EVOH), polyamides such as nylon 6, nylon 6,6, nylon 12, nylon 6,12, nylon 6,66 and blends thereof, as well as co-extruded structures of EVOH and polyamides, such as EVOH/polyamide and polyamide/EVOH/polyamide, Barrier layers also include polyvinylidene chloride (PVDC) and polychlorotrifluoroethylene (PCTFE). In particular embodiments, the barrier layers are selected from EVOH, polyamides or co-extruded structures thereof. In specific embodiments, the barrier layer is EVOH.

The multilayer structures be in the form of film(s) or sheet(s), which may be further thermoformed or oriented, and can be produced using conventional methods and extrusion equipment well known to those skilled in the art, where layers of polymer melts are combined by introducing multiple polymer melt streams into a combining block/manifold or die which then directs the melt streams to flow together (while still in the block/manifold or die), then exiting the die together as a single flow stream. Alternately, multiple polymer melt streams can be introduced into a die and then combined just after exiting the die.

The multilayer structures may also include additional layers of propylene polymer, polyethylene, barrier layers, polyamides or metal layers, provided that when a tie-layer is used it is the same as the other tie layers in the structure.

Preferably, the multilayer structure is selected from:

PE/tie-layer/barrier/tie-layer/PP/tie-layer/PE;

PE/tie-layer/barrier/tie-layer/PE/tie-layer/PP;

PP/tie-layer/barrier/tie-layer/PE/tie-layer/PP;

PE/tie-layer/barrier/tie-layer/PE/tie-layer/PE;

PP/tie-layer/barrier/tie-layer/PP/tie-layer/PP;

PE/tie-layer/barrier/tie-layer/PE;

PE/tie-layer/barrier/tie-layer/PP; or

PP/tie-layer/barrier/tie-layer/PP.

When the polymer layer is made of polyethylene (PE), the particular polyethylene may be a HDPE, LDPE, LLDPE or mixtures thereof.

### Examples

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

Grafted Polyolefin: The grafted polyolefin was the reaction product of a high density polyethylene and maleic anhydride, having a melt index of 9 grams per 10 minutes and a maleic anhydride content of 1.9 weight percent, based upon the total weight of the grafted polyolefin.

Linear Low Density Polyethylene: Equistar Chemical's STARFLEX™ GM1210 is a metallocene derived linear low density polyethylene (Hexene content: about 10%, Melt Index: 1.0 grams per 10 minutes; Density of 0.912 grams per cubic centimeter; Melting Point 116 to 118° C. determined by Differential Scanning calorimetry (DSC); Polydispersity Index: 2.74; Mₙ: 43,600; M_{w}: 119,300; M_{z}: 226,300; and M_{z+1}: 366,800).

Equistar Chemical's Petrothene® GA601 which is a Zeigler-Natta derived linear low density polyethylene (Hexene content: about 10.86%; Melt Index: 1.0 grams per 10 minutes; Density of 0.918 grams per cubic centimeter; Melting Point about 115° C.; Polydispersity Index: 5.55; Mₙ: 23,864; and M_{w}: 132,464).

Equistar Chemical's Petrothene® GA818073 is a chromium derived linear low density polyethylene (Melt Index: 0.75 grams per 10 minutes; Density of 0.92 grams per cubic centimeter; Tensile Strength at Break: 2,170 psi; Flexural Modulus: 40,000 psi; Low Temperature Brittleness, F₅₀: less than −42° C.; Vicat Softening Point: 88° C.; Hardness, Shore D: 51; Polydispersity Index: 10.83; Mₙ:10,557; and M_{w}:132,464)

Low Density Polyethylene: Equistar Chemical's PETROTHENE™ NA940 extrusion grade low density polyethylene (Melt Index: 0.25 grams per 10 minutes; Density: 0.918 grams per cubic centimeter).

TABLE 1
Tie-Layer Adhesive Compositions

| | | Second Polymer Composition | | | | |
|---|---|---|---|---|---|---|
| | First Polymer | Metallocene | Chromium | | | |
| | Composition - | derived Poly- | derived Poly- | Third Polymer | Primary | Secondary |
| | PE Graft | ethylene | ethylene-LLDPE | Composition - | antioxidant | antioxidant |
| Ex. | (wt. %) | (wt. %) | (wt. %) | LDPE | (wt. %) | (wt. %) |
| 1 | 5.5 | 94.3 | — | — | 0.1 | 0.1 |
| 2 | 5.5 | 84.3 | — | 10 | 0.1 | 0.1 |
| 3 | 5.5 | — | 94.3 | — | 0.1 | 0.1 |
| 4 | 5.5 | 84.3 | 10 | — | 0.1 | 0.1 |

The wt. % values reflected in Table 1 are based on the total weight of the tie-layer adhesive composition. The grafted polyolefin was the reaction product of a high density polyethylene and maleic anhydride, having a melt index of 9 grams per 10 minutes and a maleic anhydride content of 1.9 weight percent, based upon the total weight of the grafted polyolefin. The grafted polyolefin is commercially available from Equistar Chemicals as PMG 2300. The specific metallocene derived polyethylene (mLLDPE) used in Table 1 is Equistar Chemical's STARFLEX™ GM1210. The specific LDPE used in Table 1 is Equistar Chemical's PETROTHENE™ NA940. The specific chromium derived LLDPE used in Table 1 is commercially available from LyondellBasell as GA818073. The primary antioxidant used in the examples of Table 1 is Irganox 1010, tetrakis-(methylene-(3,5-di-(tert)-butyl-4-hydrocinnamate))methane, which is commercially available from Ciba Specialty Chemicals Corporation. The secondary antioxidant used in the examples of Table 1 is Irgafos 168, tris (2,4-di-tert-butylphenyl)phosphite, which is commercially available from Ciba Specialty Chemicals Corporation.

TABLE 2
Multilayered Films with Adhesive Compositions

| Multilayered Film | Amount (wt. %)** | Component |
|---|---|---|
| Layer 1 | 43 | HDPE |
| Layer 2 | 4 | Adhesive Composition |
| Layer 3 | 6 | Polyamide |
| Layer 4 | 4 | Adhesive Composition |
| Layer 5 | 43 | HDPE |

**The weight percent is based upon the total weight of the multilayered film.

The adhesion strength at the Polyamide/adhesive interface is measured in pounds per linear inches (PLI) in accordance with ASTM D 1876-93. Results indicate improved adhesion with the addition of LDPE.

TABLE 2
Effect of Adhesion Performance - 1 Day Adhesion

| | 3 Mil Film Adhesion | 5 Mil Film Adhesion |
|---|---|---|
| Adhesive | (pounds per linear | (pounds per linear |
| Composition | inch—PLI) | inch—PLI) |
| Ex. 1 | 1.88 | 3.486 |
| Ex. 2 | — | 3.676 |
| Ex. 3 | — | — |
| Ex. 4 | 2.14 | 4.132 |

The data in Tables 2 and 3 were generated according to the following procedure. The adhesive is coextruded with a styrenic polymer (50/50 blend of polystyrene and high impact polystyrene) and an EVOH resin having 32 mol. % of ethylene to produce multi-layer coextruded film having 24 mils of total thickness and the following construction and weight percentage of each component.

TABLE 3
Effect of Cr Catalyst on Adhesion Performance - 7 Day Adhesion

| | 3 Mil Film Adhesion | 5 Mil Film Adhesion |
|---|---|---|
| Adhesive | (pounds per linear | (pounds per linear |
| Composition | inch—PLI) | inch—PLI) |
| Ex. 1 | 2.022 | 3.664 |
| Ex. 2 | — | 3.676 |
| Ex. 3 | — | 3.89 |
| Ex. 4 | 2.128 | 4.322 |

TABLE 4
DORS Summary

| Ex. | ER | PDR |
|---|---|---|
| 1 | 0.26 | 2.02E+00 |
| 2 | 0.64 | 2.27E+00 |
| 3 | 3.95 | 2.99E+01 |
| 4 | 0.97 | 2.57E+00 |

In summary, it has been found that in a molted state the material may have high or low melt strength depending on the whether base polymer has long chain branching. A base polymer with a higher degree of long chain branching will have a higher melt strength in the molten state. If the base polymer does not have the appropriate melt strength, then the polymer composition will fall apart during the film forming process.

Also, it has been found that the long chain branching increases the melt strength in the tie-layer adhesive. A component having long chain branching may be into the tie-layer: (1) by adding a LDPE to the LLDPE; or (2) by using a LLDPE derived from a Cr based catalyst. The higher the ER the higher the long chain branching which results in an increased melt strength.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of the ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A tie-layer adhesive composition comprising:
(a) a first polymer composition comprising a grafted polyethylene;
(b) a second polymer composition comprising:
(i) a polyethylene derived from a metallocene based catalyst or a Zeigler-Natta (ZN) based catalyst, and
(ii) optionally, a polyethylene derived from a chromium based catalyst; and
(c) a third polymer composition that comprises a long chain branching polyethylene.

2. The tie-layer adhesive composition of claim 1, wherein the tie-layer adhesive comprises a primary additive.

3. The tie-layer adhesive composition of claim 2, wherein the primary additive is tetrakis-(methylene-(3,5-di-(tert)-butyl-4-hydrocinnamate))methane.

4. The tie-layer adhesive composition of claim 1, wherein the tie-layer adhesive comprises a secondary additive.

5. The tie-layer adhesive composition of claim 4, wherein the secondary additive is tris(2,4-di-tert-butylphenyl)phosphite.

6. The tie-layer adhesive composition of claim 1, wherein the tie-layer adhesive composition comprises:
(a) 2-25 wt. %, based on the total weight of the tie-layer adhesive, of the first polymer composition;
(b) 49.8-95.8 wt. %, based on the total weight of the tie-layer adhesive, of the second polymer composition; and
(c) 0.01-25 wt. %, based on the total weight of the tie-layer adhesive, of the third polymer composition.

7. The tie-layer adhesive composition of claim 6, wherein the tie-layer adhesive composition comprises:
(d) 0.001-2.0 wt. %, based on the total weight of the tie-layer adhesive, of a primary additive; and
(e) 0.001-2.0 wt. %, based on the total weight of the tie-layer adhesive, of a secondary additive.

8. The tie-layer composition of claim 7, wherein the second polymer composition comprises:
(i) 0 to 100 wt. %, based upon the total weight of the second polymer composition, of a metallocene or a Zeigler-Natta derived polyethylene; and
(ii) 0 to 100 wt. %, based upon the total weight of the second polymer composition of a chromium derived polyethylene.

9. The tie-layer composition of claim 8, wherein the second polymer composition comprises 100 wt. % of a metallocene derived polyethylene.

10. The tie-layer composition of claim 8, wherein the second polymer composition comprises about 89 wt. % of a metallocene derived polyethylene, and about 11 wt. % of a chromium derived polyethylene.

11. A multilayered structure comprising:
(A) a first polymer layer;
(B) a second polymer layer; and
(C) a tie-layer, wherein the tie-layer comprises:
(a) a first polymer composition comprising a grafted polyethylene;
(b) a second polymer composition comprising:
(i) a polyethylene derived from a metallocene based catalyst or a Zeigler-Natta (ZN) based catalyst, and
(ii) optionally, a polyethylene derived from a chromium based catalyst; and
(c) a third polymer composition that comprises a long chain branching polyethylene,
wherein the tie-layer is located between the first polymer layer and the second polymer layer, and is in contact with the first polymer layer and the second polymer layer.

12. The multilayered structure of claim 11, wherein the tie-layer adhesive comprises a primary additive.

13. The multilayered structure of claim 12, wherein the primary additive is tetrakis-(methylene-(3,5-di-(tert)-butyl-4-hydrocinnamate))methane.

14. The multilayered structure of claim 11, wherein the tie-layer adhesive comprises a secondary additive.

15. The multilayered structure of claim 14, wherein the secondary additive is tris(2,4-di-tert-butylphenyl)phosphite.

16. The multilayered structure of claim 11, wherein the tie-layer adhesive composition comprises:
(a) 2-25 wt. %, based on the total weight of the tie-layer adhesive, of the first polymer composition;
(b) 49.8-95.8 wt. %, based on the total weight of the tie-layer adhesive, of the second polymer composition; and
(c) 0.01-25 wt. %, based on the total weight of the tie-layer adhesive, of the third polymer composition.

17. The multilayered structure of claim 16, wherein the tie-layer adhesive composition comprises:
(d) 0.001-2.0 wt. %, based on the total weight of the tie-layer adhesive, of a primary additive; and
(e) 0.001-2.0 wt. %, based on the total weight of the tie-layer adhesive, of a secondary additive.

18. The multilayered structure of claim 17, wherein the second polymer composition comprises:
(i) 0 to 100 wt. %, based upon the total weight of the second polymer composition, of a metallocene or a Zeigler-Natta derived polyethylene; and
(ii) 0 to 100 wt. %, based upon the total weight of the second polymer composition of a chromium derived polyethylene.

19. The multilayered structure of claim 18, wherein the second polymer composition comprises 100 wt. % of a metallocene derived polyethylene.

20. The multilayered structure of claim 18, wherein the second polymer composition comprises about 89 wt. % of a metallocene derived polyethylene, and about 11 wt. % of a chromium derived polyethylene.
